(19) United States
(12) Patent Application Publication
(10) Pub. No.: US 2023/0331098 A1
(43) Pub. Date: Oct. 19, 2023

(54) ELECTRIC VEHICLE AGGREGATION METHOD BASED ON CONTINUOUS TRACKING OF WIND POWER CURVE

(71) Applicants: North China Electric Power University, Beijing (CN); State Grid Electric Vehicle Service Company, Beijing (CN)

(72) Inventors: Dunnan LIU, Beijing (CN); Yue ZHANG, Beijing (CN); Mingguang LIU, Beijing (CN); Heping JIA, Beijing (CN); Wen WANG, Beijing (CN); Xiaofeng PENG, Beijing (CN); Ye YANG, Beijing (CN); Shu SU, Beijing (CN)

(73) Assignees: North China Electric Power University, Beijing (CN); State Grid Electric Vehicle Service Company, Beijing (CN)

(21) Appl. No.: 17/836,298

(22) Filed: Jun. 9, 2022

(30) Foreign Application Priority Data
Apr. 19, 2022 (CN) 202210408636.4

(51) Int. Cl. B60L 15/20; B60L 53/62

(52) U.S. Cl. CPC B60L 15/2045; B60L 53/62

(57) ABSTRACT

Disclosed is an electric vehicle load aggregation method based on continuous tracking of wind power curve, including: constructing an electric vehicle load consumption wind power curve aggregation model to obtain an electric vehicle call result, and calculating the abandoned wind power through the electric vehicle call result; optimizing the abandoned wind power quantity by energy storage equipment to obtain the abandoned wind power quantity after energy storage adjustment and optimization, setting the energy storage power and capacity configuration, and constructing a wind power curve continuous tracking model after energy storage adjustment and optimization; and solving the charging and discharging power of the energy storage equipment in each time period based on the wind power curve continuous tracking model after the energy storage adjustment and optimization, and calculating the cost of output aggregation.

### CROSS-REFERENCE TO RELATED APPLICATIONS

This application claims priority to Chinese Patent Application No. 202210408636.4, filed on Apr. 19, 2022, the contents of which are hereby incorporated by reference.

### TECHNICAL FIELD

The application relates to the technical field of load aggregation control, and in particular to an electric vehicle aggregation method based on continuous tracking of a wind power curve.

### BACKGROUND

Under the dual background of gradual shortage of fossil energy and increasingly serious environmental problems, the advantages of renewable clean energy, such as wind power and photovoltaic, are gradually highlighted; however, due to random and fluctuated power generation, energy consumption is facing great challenges. Fully regulating flexible and controllable resources on the demand side to participate in the new energy curve tracking can reduce negative impacts of intermittent clean energy output fluctuations and establish a clean and efficient energy system.

Electric vehicles have great potential in new energy consumption because of flexible and controllable load characteristics. At present, a great deal of research has been done to integrate electric vehicle loads into market dispatch, so as to track the new energy curve. However, there is still a lack of optimization means in fully mobilizing flexible side resources to absorb large-scale clean energy, and the continuous tracking of curves requires finer time granularity. Therefore, it is necessary to develop an optimized aggregation method for continuous tracking of new energy curves for electric vehicle loads, to give full play to the potential of demand-side resources to consume new energy and to help build a new power system with a high proportion of renewable energy.

### SUMMARY

Aiming at the problems existing in regulating and consuming new energy by electric vehicle aggregation mentioned in the prior art, this application puts forward an electric vehicle aggregation method based on continuous tracking of wind power curves, which fully considers the aggregation scale of electric vehicle aggregation, load complementary constraint and energy storage adjustment, and determines the method of continuous tracking of wind power curves by electric vehicles.

To achieve the above objective, this application provides the following solutions:
constructing an electric vehicle load consumption wind power curve aggregation model to obtain an electric vehicle call result, and calculating an abandoned wind power quantity through the electric vehicle call result;
optimizing the abandoned wind power quantity by energy storage equipment to obtain an abandoned wind power quantity after energy storage adjustment and optimization, setting an energy storage power and capacity configuration, and constructing a wind power curve continuous tracking model after energy storage adjustment and optimization; and
solving a charging and a discharging power of the energy storage equipment in each time period based on the wind power curve continuous tracking model after the energy storage adjustment and optimization, and calculating a cost of output aggregation, so as to obtain an electric vehicle aggregation continuous tracking wind power curve scheme after the final output cost and deviation are optimized.

In an embodiment, a process of constructing the electric vehicle load consumption wind power curve aggregation model includes:

collecting wind power output, obtaining predicted wind power output through prediction algorithm, collecting charging loads of all electric vehicles, and adding the charging loads of all electric vehicles in the same period to obtain electric vehicle charging aggregate load; taking a minimum absolute value of the numerical difference between the electric vehicle charging aggregate load and the predicted wind power output as the objective function, and taking an aggregate load scale and a load complementation of electric vehicles as constraints, constructing an aggregation model of electric vehicle load consumption wind power curve.

In an embodiment, an objective function of the wind power curve aggregation model of electric vehicle load consumption is:

$$min {F}_{1} = {\sum }_{t = 1}^{T} \vert ( {W}_{t} - ( {P}_{t} + {\sum }_{l = 1}^{N} {k}_{i} \cdot {P}_{i , t}^{E} - {V}_{t} ) ) Δ t$$

where F₁ is the deviation between electric vehicle load aggregation and wind power, Wₜ is the predicted wind power of wind power plant in time t period, Pₜ is the power of power side load except electric vehicle load in time t period, kᵢ is 0-1 decision variable, P_{i,t}^{E} is the load of the i^{th} charging station in time t period, Vₜ is the output power of other power plants except wind power in time t period, T is the number of time periods, ΔT is the sampling time, and N is the number of charging stations participating in the aggregation in the curve continuous tracking.

In an embodiment, constraint conditions of the aggregate load scale and the load complementation include:
load scale constraint is a ratio of aggregate load resources to total resources on demand side:

$${\sum }_{i = 1}^{N} {\sum }_{t = 1}^{T} {k}_{i} \cdot {P}_{i , t}^{E} \geq φ \cdot Q$$

where N is the number of charging stations participating in the aggregation in the curve continuous tracking, T is the number of time periods, kᵢ is the 0-1 decision variable of the i^{th} charging station, P_{i,t}^{E} is the load of the i^{th} charging station in time t period, φ is the minimum proportion of the aggregated resources of electric vehicles to the resources on the demand side, and Q is the power quantity of the resources on the demand side;
load complementation constraint is a characteristic complementation constraint among different load curves:

$${r}_{i , j , t} = \frac{{min}_{i} {min}_{t} \vert {P}_{i , t}^{E} - {P}_{jt}^{E} \vert + ρ {max}_{i} {max}_{t} \vert {P}_{i , t}^{E} - {P}_{j , t}^{E} \vert}{\vert {P}_{i , t}^{E} - {P}_{j , t}^{E} \vert + ρ {max}_{i} {max}_{t} \vert {P}_{i , t}^{E} - {P}_{j , t}^{E} \vert}$$

$${r}_{i , j} = \frac{1}{T} {\sum }_{t = 1}^{T} {r}_{i , j , t}$$

$${k}_{i} \cdot {k}_{j} {r}_{i , j} or {k}_{i} \cdot {k}_{j} {r}_{i , j} = 0$$

where

$${min}_{i} and {min}_{t}$$

represent the minimum among different values of i and the minimum among different values of t, P_{i,t}^{E} represents the load of the i^{th} charging station in time t period, P^{E}ⱼₜ represents the load of the j^{th} charging station in time t period,

$${min}_{i} {min}_{t}$$

represent the maximum among different values of i and the maximum among different values of t, and r_{i,j,t} represents the correlation degree between the load curve of the i^{th} charging station and the load curve of the j^{th} charging station at the t time point. r_{i,j} is the complementary coefficient between the load curves of the i and j charging stations, a is the resolution coefficient, T is the number of time periods, kᵢ is the 0-1 decision variable of the i charging station, kⱼ is the 0-1 decision variable of the j charging station, and rₘᵢₙ the lower limit of load complementarity.

In an embodiment, a process of calculating the abandoned wind power quantity through the calling result includes:

$${Q}_{t} = ( {W}_{t} - ( {P}_{t} + {\sum }_{i = 1}^{N} {k}_{i} \cdot {P}_{i , t}^{E} - {V}_{t} ) ) Δ T ;$$

$$if {Q}_{t} > 0 , let {\dot{Q}}_{t} = {Q}_{t} ; if {Q}_{t} \leq 0 , let {Q}_{t}^{′} = 0 ;$$

$${F}_{2} = {\sum }_{t = 1}^{T} {Q}_{t}^{′}$$

where Qₜ is the difference between wind power and other conventional power generation quantities and loads in time t period, Wₜ is the predicted wind power of the wind power plant in time t period, Pₜ is the power of the power side loads except the electric vehicle loads in time t period, N is the number of charging stations participating in the aggregation in the curve continuous tracking, kᵢ is the 0-1 decision variable of the i^{th} charging station, and P_{i,t}^{E} is the load of the i^{th} charging station in time t period; Vₜ refers to the output power of other power plants except wind power in time t period, T refers to the number of periods, ΔT refers to the sampling time, Qₜ refers to the abandoned wind power in time t period, and F₂ refers to the abandoned wind power in each period after electric vehicles are aggregated and called.

In an embodiment, a process of constructing the wind power curve continuous tracking model after the energy storage adjustment optimization includes:

optimizing the abandoned wind power quantity of electric vehicles after aggregation and call by the energy storage device, and absorbing the abandoned wind power quantity before optimization of the energy storage device; taking the optimized minimum abandoned wind power quantity as the objective function, a configuration range of energy storage power and capacity and running constraints of electric vehicles are given, and constructing the wind power curve continuous tracking model of electric vehicles after energy storage adjustment and optimization.

In an embodiment, an objective function of the wind power curve continuous tracking model of the electric vehicle after the energy storage adjustment and optimization is constructed as:

$$min {F}_{3} = {\sum }_{t = 1}^{T} {Q}_{t}^{′}$$

where F₃ is the abandoned wind power after energy storage adjustment and optimization, \dot{Q}ₜ is the abandoned wind power in time t period, and T is the number of periods.

In an embodiment, operation constraints of the electric vehicle include:

$${F}_{3} \leq {F}_{2}$$

$$0 \leq {s}_{t} \leq {λ}_{s , t} \cdot {d}_{i}^{max} < {P}_{ESS}$$

$$0 \leq {d}_{t} \leq {λ}_{d , t} \cdot {d}_{i}^{max} < {P}_{ESS}$$

$${λ}_{s , t} + {λ}_{d , t} \leq 1$$

$$SOC ( t + 1 ) = SOC ( t ) + ( {s}_{t} \times \sqrt{μ} - \frac{{d}_{t}}{\sqrt{μ}} ) Δ t$$

$$SOC ( t ) < {G}_{ESS}$$

where F₃ is the abandoned wind power after energy storage adjustment and optimization, F₂ is the sum of abandoned wind power in each period after electric vehicle aggregation and call, sₜ and dₜ are the charging and discharging power of energy storage at time t, μ is the charging and discharging efficiency of energy storage equipment, λ_{s,t} and λ_{d,t} are 0-1 variables of charging and discharging state of energy storage system at time t, and dₜ^{max} is the maximum value of discharging power. P_{ESS} and G_{ESS} are the upper limits of charging and discharging power and capacity of energy storage equipment, SOC(t) is the state of charge of energy storage equipment at time t, SOC(t+1) is the state of charge of energy storage equipment at time t+1, and ΔT is the sampling time.

In an embodiment, a process of calculating the cost of output aggregation to obtain the electric vehicle aggregation continuous tracking wind power curve scheme with optimized final output cost and deviation includes:

collecting electric vehicle energy storage power unit price, capacity allocation unit price, market catalog electricity price and contract electricity price, and calculating default cost, opportunity cost and energy storage use cost by combining the electric vehicle energy storage power unit price, capacity allocation unit price, market catalog electricity price and contract electricity price, and obtaining aggregate cost in each time period; obtaining aggregate tracking total cost in each time period based on the summation of aggregate cost in each time period, and selecting a tracking scheme with a smallest aggregate tracking total cost as a final output cost and deviation optimized electric vehicle aggregate continuous tracking wind power curve scheme.

The application has the beneficial effects that the electric vehicle load is aggregated to participate in the market dispatch, the tracking of the new energy curve is realized, the flexible side resources are fully mobilized to absorb large-scale clean energy by better optimization means; and the curve continuously tracks the finer time granularity, so that the continuous tracking of renewable energy curves such as wind power with higher accuracy is realized, and the economic cost of aggregation is reduced.

### BRIEF DESCRIPTION OF THE DRAWINGS

In order to more clearly explain the embodiments of this application or the technical solutions in the prior art, the following will briefly introduce the drawings needed in the embodiments. Obviously, the drawings in the following description are only some of the embodiments of this application. For those of ordinary skill in this field, other drawings can be obtained according to these drawings without any creative labor.

FIG. 1 is a graph of aggregate load and wind abandonment after energy storage adjustment and optimization according to an embodiment.

FIG. 2 is a graph of aggregated load and wind abandonment of electric vehicles according to an embodiment.

### DETAILED DESCRIPTION OF THE EMBODIMENTS

The technical solutions in the embodiments of this application will be clearly and completely described below with reference to the drawings in the embodiments of this application. Obviously, the described embodiments are only part of the embodiments of this application, rather than all of the embodiments. Based on the embodiments in this application, all other embodiments obtained by those of ordinary skill in this field without creative labor belong to the scope of protection in this application.

In order to make the above objectives, features and advantages of this application more obvious and understandable, the application will be further explained in detail below with reference to the drawings and detailed description.

The application discloses an electric vehicle load aggregation method based on continuous tracking of wind power curves. Based on research, the electric vehicle load aggregation is involved in market scheduling, and the tracking of new energy curves is realized, which can solve the problem in the prior art that lacking of optimization means in fully mobilizing flexible side resources to absorb large-scale clean energy. The time granularity of continuous tracking of curves is finer, which can realize the continuous tracking of renewable energy curves such as wind power with higher precision, and at the same time reduce the economic cost of aggregation. The method includes the following steps.

(1) Collecting data including charging load, wind power output, market catalogue price, contract price, unit price of energy storage power and unit price of capacity of each electric vehicle.

(2) Obtaining a predicted power of wind power output by common prediction algorithms including long-term and short-term memory neural network, BP neural network, least squares support vector machine and artificial intelligence algorithm; taking a minimum absolute value of the difference between the electric vehicle charging aggregate load and the predicted wind power output as an objective function, constructing a wind power curve aggregation model of electric vehicle load consumption, and obtaining the call result of electric vehicle;

obtaining a charging aggregate load of electric vehicles by collecting the charging loads of all electric vehicles and adding the charging loads of all electric vehicles in the same period.

An objective function:

$$min {F}_{1} = {\sum }_{t = 1}^{T} \vert ( {W}_{t} - ( {P}_{t} + {\sum }_{l = 1}^{N} {k}_{i} \cdot {P}_{i , t}^{E} - {V}_{1} ) ) Δ T \vert$$

where F₁ is the deviation between electric vehicle load aggregation and wind power, Wₜ is the predicted wind power of wind power plant in time t period, Pₜ is the power of electric side load except electric vehicle load in time t period, kᵢ is 0-1 decision variable, P_{i,t}^{E} is the load of the i^{th} charging station (pile) in time t period, Vₜ is the output power of other power plants except wind power in time t period, N is the number of charging stations participating in aggregation in curve continuous tracking, T is 96, and ΔT is a sampling duration of 15 min.

Constraints:
scale constraint: aggregate load resources must be greater than a certain proportion of total resources on the demand side;

$${\sum }_{i = 1}^{N} {\sum }_{t = 1}^{T} {k}_{i} \cdot {P}_{i , t}^{E} \geq φ \cdot Q$$

where N is the number of charging stations participating in the aggregation in the curve continuous tracking, T is the number of time periods 96, kᵢ is the 0-1 decision variable of the i^{th} charging station, P_{i,t}^{E} is the load of the i^{th} charging station in time t period, φ is the minimum proportion of the aggregated resources of electric vehicles to the resources on the demand side, and Q is the power quantity of the resources on the demand side;
complementarity constraint: different load curves must meet the characteristic complementarily constraint;

$${r}_{i , j , t} = \frac{{min}_{i} {min}_{t} \vert {{P}^{E}}_{i , t} - {{P}^{E}}_{jt} \vert + ρ {max}_{i} {max}_{t} \vert {{P}^{E}}_{i , t} - {{P}^{E}}_{j , t} \vert}{\vert {{P}^{E}}_{i , t} - {{P}^{E}}_{j , t} \vert + ρ {max}_{i} {max}_{t} \vert {{P}^{E}}_{i , t} - {{P}^{E}}_{j , t} \vert}$$

$${r}_{i , j} = \frac{1}{T} {\sum }_{t = 1}^{T} {r}_{i , j , t}$$

$${k}_{i} {k}_{j} {r}_{i , j} \geq {r}_{min} or {k}_{i} {k}_{j} {r}_{i , j} = 0$$

where

$${min}_{i} {min}_{t}$$

means taking the minimum among different i values and the minimum among different T values, P_{i,t}^{E} is the load of the i^{th} charging station in time t period, P^{E}ⱼₜ is the load of the j^{th} charging station in time t period,

$${max}_{i} {max}_{t}$$

means taking the maximum among different i values and taking the maximum among different T values, r_{i,j,t} is the correlation degree between the load curve of the i^{th} charging station and the load curve of the j^{th} charging station at T time point, and r_{i,j} is the complementary coefficient between the load curves of the i^{th} and the j^{th} charging stations; ρ is the discrimination coefficient, and the value is selected according to the experience in (0,1); if ρ is smaller, the difference between correlation coefficients will be larger and the discrimination ability will be stronger; T is the number of time periods 96, kᵢ is the 0-1 decision variable of the i^{th} charging station, and kⱼ is the 0-1 decision variable of the jth charging station; rₘᵢₙ is the lower limit of load complementarity, and the load curves participating in the polymerization should satisfy that the complementary coefficient between pairs is greater than the lower limit of load complementarity.

(3) Calculating an abandoned wind power after the electric vehicle load tracking wind power curve calling scheme is obtained in S2.

$${Q}_{t} = ( {W}_{t} - ( {P}_{t} + {\sum }_{i = 1}^{N} {k}_{i} {P}_{i , t}^{E} - {V}_{t} ) ) Δ T$$

$$if {Q}_{t} > 0 , let {Q}_{t}^{′} = {Q}_{t} ; if {Q}_{t} \leq 0 , let {Q}_{t}^{′} = 0 ;$$

$${F}_{2} = {\sum }_{t = 1}^{T} {{Q}_{t}}^{′}$$

where Qₜ is the difference between wind power and other conventional power generation quantities and loads in time t period, Wₜ is the predicted wind power of the wind power plant in time t period, Pₜ is the power of the power side loads except the electric vehicle loads in time t period, N is the number of charging stations participating in the aggregation in the curve continuous tracking, kᵢ is the 0-1 decision variable of the i^{th} charging station, and P_{i,t}^{E} is the load of the i^{th} charging station in time t period; Vₜ is the output power of other power plants except wind power in time t period, T is the number of time periods 96, ΔT is the sampling time 15 min, \dot{Q}ₜ is the abandoned wind power in time t period, and F₂ is the abandoned wind power in each period after the aggregation and call of electric vehicles.

(4) Optimizing the abandoned wind power of electric vehicles after aggregation and call by using energy storage equipment, absorbing the abandoned wind power before energy storage optimization, and setting the energy storage power and capacity configuration, considering the operation constraints, in order to build a wind power curve continuous tracking model of electric vehicles after energy storage adjustment and optimization, and to solve the charging and discharging power of each period of energy storage.

The objective function:

$$min {F}_{3} = {\sum }_{t = 1}^{T} {{Q}_{t}}^{′}$$

where F₃ is the abandoned wind power quantity after energy storage adjustment and optimization, T is the number of time periods 96, \dot{Q}ₜ is the abandoned wind power quantity in t^{th} time period, and T is the number of time periods 96.

Constraints:

$${F}_{3} \leq {F}_{2}$$

$$0 \leq {s}_{f} \leq {λ}_{s , t} {d}_{t}^{max} < {P}_{ESS}$$

$$0 \leq {d}_{t} \leq {λ}_{d , t} {d}_{t}^{max} < {P}_{ESS}$$

$${λ}_{s , t} + {λ}_{d , t} \leq 1$$

$$SOC ( t + 1 ) = SOC ( t ) + ( {s}_{i} \times \sqrt{μ} - \frac{{d}_{t}}{\sqrt{μ}} ) Δ t$$

$$SOC ( t ) < {G}_{ESS}$$

where F₃ is the abandoned wind power after energy storage adjustment and optimization, F₂ is the sum of abandoned wind power in each period after electric vehicle aggregation and call, sₜ and dₜ are the charging and discharging power of energy storage at time t, μ is the charging and discharging efficiency of energy storage equipment, λ_{s,t} and λ_{d,t} are 0-1 variables of charging and discharging state of energy storage system at time t, and dₜ^{max} is the maximum of discharging power. P_{ESS} and G_{ESS} are the upper limits of charging and discharging power and capacity of energy storage equipment, SOC(t) is the state of charge of energy storage equipment at time t, SOC(t+1) is the state of charge of energy storage equipment at time t+1, and ΔT is the sampling time of 15 min.

(5) Constantly adjusting the energy storage configuration, bringing the configuration value into (4) for solution, calculating the cost of each output aggregation scheme, and selecting the tracking scheme with the smallest aggregate total cost as the final output scheme.

The default cost:

$${C}_{1} = {P}_{1} ( {Q}_{0} - {\sum }_{i}^{N} {k}_{i} {Q}_{i , 1} )$$

The opportunity cost:

$${C}_{2} = {P}_{2} ( {\sum }_{i}^{N} {θ}_{i} {Q}_{i , 2} - {Q}_{0} )$$

The energy storage cost:

C₃=θ₁P_{ESS}+θ₂G_{ESS}

C_{T}=C₁+C₂+C₃

where c₁, c₂, c₃ and cᵣ are respectively default cost, opportunity cost, energy storage cost and aggregate tracking total cost; P₁ and P₂ are the unit price of liquidated damages and the contract electricity price respectively, and the market catalogue electricity price is adopted in this application; Q₀ is the aggregate consumption power specified in the contract, and kᵢ is the 0-1 decision variable of the i^{th} charging station; Q_{i,1} and Q_{i,2} refer to the amount of electricity that has not been traced in breach of contract and the amount of electricity that exceeds the contract; θ₁ and θ₂ refer to the unit price of stored power and the unit price of capacity. P_{ESS} and G_{ESS} respectively refer upper limits for charging and discharging power and capacity of energy storage equipment.

Taking the continuous tracking of wind power curve in a certain area as an example, collecting data such as charging power of electric vehicles, predicted wind power output, market catalogue price and contract price, and aggregating the charging load of electric vehicles to continuously track the wind power curve in this area. The specific data are shown in Table 1 model basic parameters.

TABLE 1

| | Minimum | | | | Energy | Energy |
|---|---|---|---|---|---|---|
| Resolution | complementary | | Catalogue | Contract | storage | storage |
| coefficient | coefficient | Charging | electricity | electricity | unit | unit |
| ρ | rₘᵢₙ | efficiency | price | price | price | price |
| 0.5 | 0.3 | 90% | 1 RMB/KW | 0.8 RMB/kW | 0.2 RMB/kW | 0.3 RMB/kWh |

With the objective of minimizing the absolute deviation between electric vehicle aggregate load and wind power curve, inputting the collected electric vehicle charging power, and solving the call result of electric vehicle by using CPLEX toolbox of Matlab, as shown in Table 2.

TABLE 2

| | Whether |
|---|---|
| | participate in |
| NO. of | aggregation |
| electric | (yes-1; |
| vehicle | No -0) |
| 1 | 1 |
| 2 | 0 |
| 3 | 0 |
| 4 | 1 |
| 5 | 0 |
| 6 | 1 |
| 7 | 1 |
| 8 | 1 |
| 9 | 1 |
| 10 | 1 |
| 11 | 1 |
| 12 | 1 |
| 13 | 1 |
| 14 | 1 |
| 15 | 1 |
| 16 | 1 |
| 17 | 0 |
| 18 | 1 |
| 19 | 1 |
| 20 | 1 |
| 21 | 1 |
| 22 | 0 |
| 23 | 0 |
| 24 | 1 |
| 25 | 1 |
| 26 | 1 |
| 27 | 0 |
| 28 | 1 |
| 29 | 1 |
| 30 | 0 |

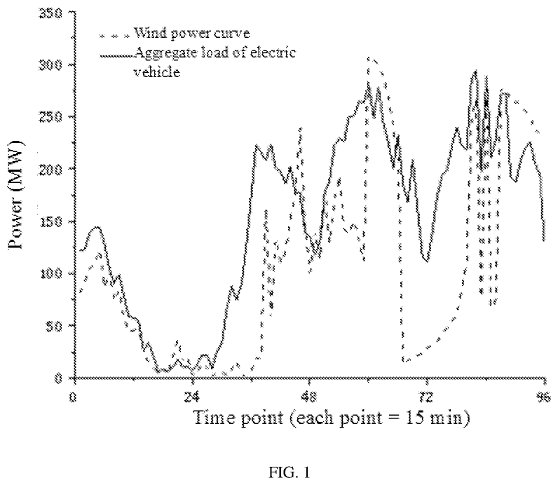

Under the call result, the deviation of wind power curve of electric vehicle aggregate load tracking is 203.14 MWh, and the curve of electric vehicle aggregate load and wind power is shown in FIG. 1.

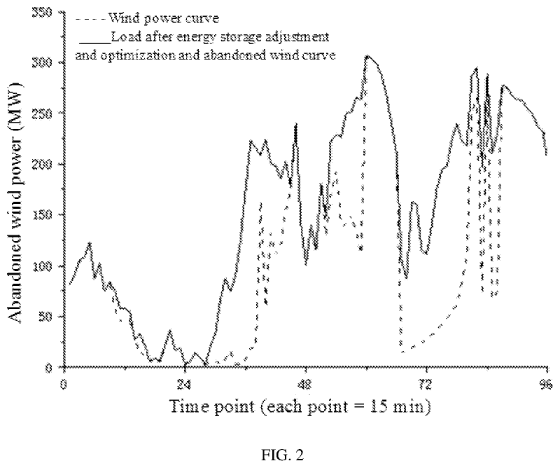

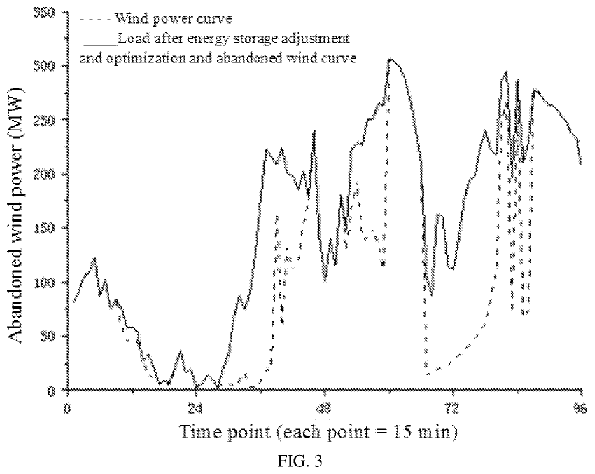

With the objective of minimizing the abandoned wind power after the electric vehicle tracks the wind power curve after the adjustment and optimization of energy storage, imputing the electric vehicle call load, and calculating the charging and discharging power of each period of energy storage by using the CPLEX toolbox of Matlab. According to experience, the adjustment range of energy storage power is 2-24MW, the capacity range is 6-12 MWh, and calculating the aggregation deviation, default cost, opportunity cost, energy storage cost and total aggregation cost under different energy storage power and capacity configurations, as shown in Table 3. Within the above range, solving the scheme with the lowest aggregation cost, the energy storage power is 16MW and the capacity is 8 MWh. At this time, the curve of aggregation load and wind power is shown in FIG. 2.

TABLE 3

| Capacity | Power | Polymerization | Default | | Energy | Aggregation |
|---|---|---|---|---|---|---|
| configuration/ | configuration/ | deviation/ | cost/ | Opportunity | storage cost/ | cost/ |
| (MWh) | (MWh) | MWh | (RMB) | cost | (RMB) | (RMB) |
| / | / | 203.14 | 3359.89 | 38608.26 | 0 | 41968.15 |
| 6 | 14 | 141.29 | 2123.25 | 37277.91 | 4600 | 44001.16 |
| 6 | 16 | 135.04 | 2025.02 | 37165.41 | 5000 | 44190.43 |
| 8 | 14 | 76.90 | 1066.34 | 35608.67 | 5200 | 41875.01 |
| 8 | 16 | 63.20 | 866.34 | 35310.07 | 5600 | 41776.41 |
| 8 | 18 | 51.30 | 717.39 | 35065.49 | 6000 | 41782.88 |
| 10 | 14 | 60.95 | 773.04 | 35346.17 | 5800 | 41919.21 |
| 10 | 16 | 48.70 | 623.04 | 35010.07 | 6200 | 41833.11 |
| 10 | 18 | 39.30 | 492.39 | 34727.99 | 6600 | 41820.38 |

Without energy storage adjustment, the deviation of tracking wind power curve is 203.14 MWh, the default cost is 3,359.89 RMB, the opportunity cost is 38,608.26 RMB, and the total aggregate cost is 41,968.15 RMB. The tracking wind power curve deviation of the electric vehicle aggregation method based on continuous tracking of wind power curve provided in this application is 63.20 MWh, the default cost is 866.34 RMB, the opportunity cost is 35,310.07 RMB, the energy storage cost is 5,600 RMB, and the total aggregation cost is 41,776.41 RMB, which can realize the continuous tracking of renewable energy curves such as wind power with higher accuracy and reduce the economic cost of aggregation.

The above-mentioned embodiments are only descriptions of the preferred mode of this application, and do not limit the scope of this application. Without departing from the design spirit of this application, all kinds of modifications and improvements made by those of ordinary skill in this field to the technical scheme of this application shall fall within the scope of protection determined by the claims of this application.

1-9. (canceled)

10. An electric vehicle load aggregation method based on continuous tracking of a wind power curve, comprising:
constructing an electric vehicle load consumption wind power curve aggregation model to obtain an electric vehicle call result, and calculating an abandoned wind power quantity through the electric vehicle call result;
wherein a process of constructing the electric vehicle load consumption wind power curve aggregation model comprises:
collecting a wind power output, obtaining a predicted wind power output through a prediction algorithm, collecting charging loads of all the electric vehicle, and adding the charging loads of all the electric vehicle in a same period to obtain electric vehicle charging aggregate loads; taking a minimum absolute value of a numerical difference between the electric vehicle charging aggregate loads and the predicted wind power output as an objective function, and taking an aggregate load scale and a load complementation of the electric vehicle as constraints, and constructing the electric vehicle load consumption wind power curve aggregation model;
wherein the objective function of the electric vehicle load consumption wind power curve aggregation model is:
$$min {F}_{1} = {\sum }_{t = 1}^{T} \vert ( {W}_{t} - ( {P}_{t} + {\sum }_{i = 1}^{N} {k}_{i} {P}_{i , t}^{E} - {V}_{t} ) ) Δ T \vert$$
wherein F₁ represents a deviation between the electric vehicle load after an aggregation and a call and a wind power, Wₜ represents the predicted wind power output of a wind power plant in a time t period, Pₜ represents a power of a power side load except an electric vehicle load in the time t period, kᵢ represents a 0-1 decision variable, P_{i,t}^{E} represents a load of an i^{th} charging station in the time t period, Vₜ represents an output power of other power plants except the wind power in the time t period, T represents a number of time periods, ΔT represents a sampling duration, and N represents a number of charging stations participating in the aggregation in a curve continuous tracking;
wherein the constraint conditions of the aggregate load scale and the load complementation comprise:
a load scale constraint: a ratio of aggregate load resources to total resources on demand side:
$${\sum }_{i = 1}^{N} {\sum }_{i = 1}^{T} {k}_{i} {P}_{i , t}^{E} \geq φ Q ,$$
wherein N represents the number of the charging stations participating in the aggregation in the curve continuous tracking, T represents the number of the time periods, kᵢ represents the 0-1 decision variable of the i^{th} charging station, represents the load of the i^{th} charging station in the time t period, φ represents a minimum proportion of aggregated resources of the electric vehicle to resources on a demand side, and Q represents a power quantity of the resources on the demand side; and
a load complementation constraint: a characteristic complementation constraint among different load curves:
$${r}_{i , j , t} = \frac{{min}_{i} {min}_{t} \vert {{P}^{E}}_{i , t} - {{P}^{E}}_{jt} \vert + ρ {max}_{i} {max}_{t} \vert {{P}^{E}}_{i , t} - {{P}^{E}}_{j , t} \vert}{\vert {{P}^{E}}_{i , t} - {{P}^{E}}_{j , t} \vert + ρ {max}_{i} {max}_{t} \vert {{P}^{E}}_{i , t} - {{P}^{E}}_{j , t} \vert}$$
$${r}_{i , j} = \frac{1}{T} {\sum }_{t = 1}^{T} {r}_{i , j , t}$$
$${k}_{i} {k}_{j} {r}_{i , j} \geq {r}_{min} or {k}_{i} {k}_{j} {r}_{i , j} = 0$$
wherein
$${min}_{i} and {min}_{t}$$
represent the minimum among different values of i and the minimum among different values of t, P_{i,t}^{E} represents the load of the i^{th} charging station in time t period, P^{E}ⱼₜ represents the load of the j^{th} charging station in the time t period,
$${max}_{i} {max}_{t}$$
represent the maximum among different values of i and the maximum among different values of t, and r_{i,j,t} represents a correlation degree between the load curve of the i^{th} charging station and the load curve of the j^{th} charging station at a t time point; r_{i,j} represents a complementary coefficient between the load curves of the i and j charging stations, ρ represents a resolution coefficient, T represents the number of the time periods, kᵢ represents the 0-1 decision variable of the i charging station, kⱼ represents the 0-1 decision variable of the j charging station, and rₘᵢₙ represents a lower limit of load complementarity;
optimizing an abandoned wind power quantity by energy storage equipment to obtain the abandoned wind power quantity after an energy storage adjustment and optimization, setting an energy storage power and capacity configuration, and constructing a wind power curve continuous tracking model after the energy storage adjustment and optimization;
wherein a process of constructing the wind power curve continuous tracking model after the energy storage adjustment and optimization comprises:
optimizing the abandoned wind power quantity of the electric vehicle after the aggregation by the energy storage equipment, and absorbing the abandoned wind power quantity before the optimization of the energy storage equipment; taking an optimized minimum abandoned wind power quantity as the objective function, setting a configuration range of energy storage power and capacity and operation constraints of the electric vehicle, and constructing the wind power curve continuous tracking model of the electric vehicle after the energy storage adjustment and optimization; and constructing the objective function of the wind power curve continuous tracking model of the electric vehicle after the energy storage adjustment and optimization as:
min F₃=Σₜ₌₁^{T}qₜ,
wherein F₃ represents the abandoned wind power after the energy storage adjustment and optimization, qₜ represents the abandoned wind power in the time t period, and T represents the number of the periods;
the operation constraints of the electric vehicle comprise:
$${F}_{3} \leq {F}_{2}$$
$$0 \leq {S}_{t} \leq {δ}_{s , t} \cdot {d}_{t}^{max} < {P}_{ESS}$$
$$0 \leq {d}_{t} \leq {δ}_{d , t} \cdot {d}_{t}^{max} < {P}_{ESS}$$
$${λ}_{s , t} + {δ}_{d , t} \leq 1$$
$$SOC ( t + 1 ) = SOC ( t ) + ( {s}_{i} \times \sqrt{μ} - \frac{{d}_{t}}{\sqrt{μ}} ) Δ t$$
$$SOC ( t ) < {G}_{ESS}$$
wherein F₃ represents the abandoned wind power after the energy storage adjustment and optimization, F₂ represents a sum of the abandoned wind power in each period after the electric vehicle aggregation and call, sₜ and dₜ represent a charging power and a discharging power of the energy storage at time t respectively, represents a charging and discharging efficiency of the energy storage equipment, λ_{s,t} and δ_{d,t} represent the 0-1 variables of a charging state and a discharging state of an energy storage system at time t, and dₜ^{max} represents the maximum value of the discharging power; P_{ESS} and G_{ESS} represent upper limits of the charging and discharging power and capacity of the energy storage equipment, SOC(t) represents the state of charge of the energy storage equipment at time t, SOC(t+1) represents the state of charge of the energy storage equipment at time t+1, and ΔT represents a sampling duration;
and solving the charging and discharging power of the energy storage equipment in each time period based on the wind power curve continuous tracking model after the energy storage adjustment and optimization, and calculating a cost of output aggregation, and obtaining an electric vehicle aggregation continuous tracking wind power curve scheme with optimized final output cost and deviation.

11. The electric vehicle load aggregation method based on the continuous tracking of the wind power curve according to claim 10, wherein a process of calculating the abandoned wind power quantity through the electric vehicle call result comprises:
$${Q}_{t} = ( {W}_{t} - ( {P}_{t} + {\sum }_{i = 1}^{N} {k}_{i} {P}_{i , t}^{E} - {V}_{t} ) ) Δ T$$
$$if {Q}_{t} > 0 , letting {Q}_{t}^{′} = {Q}_{t} ; if {Q}_{t} \leq 0 , letting {q}_{t} = 0 ;$$
$${F}_{2} = {\sum }_{t = 1}^{T} {q}_{t} ,$$
wherein Qₜ represents the difference between the wind power and other traditional power generation quantities and loads in the time t period, Wₜ represents the predicted wind power of the wind power plant in the time t period, Pₜ represents the power of the power side loads except the electric vehicle loads in the time t period, N is the number of the charging stations participating in the aggregation in the curve continuous tracking, kᵢ represents the 0-1 decision variable of the i^{th} charging station, and P_{i,t}^{E} represents the load of the i^{th} charging station in the time t period; Vₜ represents the output power of other power plants except the wind power in the time t period, T represents the number of periods, ΔT represents the sampling duration, qₜ represents the abandoned wind power in the time t period, and F₂ represents the abandoned wind power in each period after the electric vehicle are aggregated and called.

12. The electric vehicle load aggregation method based on the continuous tracking of the wind power curve according to claim 11, wherein a process of calculating the cost of an output aggregation to obtain the electric vehicle aggregation continuous tracking wind power curve scheme with optimized final output cost and deviation comprises:
collecting an electric vehicle energy storage power unit price, a capacity allocation unit price, a market catalog electricity price and a contract electricity price, and calculating a default cost, an opportunity cost and an energy storage use cost by combining the electric vehicle energy storage power unit price, the capacity allocation unit price, the market catalog electricity price and the contract electricity price, and obtaining an aggregate cost in each time period; obtaining an aggregate tracking total cost in each time period based on a summation of the aggregate cost in each time period, and selecting a tracking scheme with a smallest aggregate tracking total cost as the electric vehicle aggregation continuous tracking wind power curve scheme with optimized final output cost and deviation.
